(19) United States
(12) Patent Application Publication
(10) Pub. No.: US 2026/0157493 A1
(43) Pub. Date: Jun. 11, 2026

(54) Smart Luggage

(71) Applicant: Deborah McCullough, Douglasville, GA (US)

(72) Inventor: Deborah McCullough, Douglasville, GA (US)

(21) Appl. No.: 19/416,873

(22) Filed: Dec. 11, 2025

Related U.S. Application Data
(60) Provisional application No. 63/730,481, filed on Dec. 11, 2024.

(51) Int. Cl. A45C 13/24; A45C 5/03; A45C 5/14; G06V 40/12; G06V 40/13; G08B 13/22

(52) U.S. Cl. CPC A45C 13/24; A45C 5/03; A45C 5/14; G06V 40/13; G06V 40/1365; G08B 13/22

(57) ABSTRACT

Anti-theft smart luggage that prevents the luggage from being stolen. A biometric reader, preferably a fingerprint reader, ideally positioned on the handle of the luggage to detect the owner of the luggage is lifting the luggage telescoping handle. If the owner of the luggage is not detected, then the handle will not telescope, luggage wheels will lock, and an alarm and lights will flash to attract attention and prevent the luggage from being easily moved. Straps allowing the luggage to open will also not unlock if the luggage owner cannot be verified. Remote unlocking and locking of the luggage is also possible.

### CONTINUITY

This application is a non-provisional patent application of provisional patent application No. 63/730,481 filed on Dec. 11, 2024, and priority is claimed thereto.

### FIELD OF THE PRESENT INVENTION

The present invention relates to the field of travel devices, and more specifically relates to anti-theft smart luggage. The luggage is equipped with security features to not only prevent the luggage from being stolen, but to deter luggage theft from the get-go.

### BACKGROUND OF THE PRESENT INVENTION

Now that the pandemic seems to have subsided, travel is at an all-time high. Highways are busier than they have been in years. Airports, train stations, and bus terminals are busy again as well.

The beauty of driving to a destination in an automobile is that a traveler can leave whenever the traveler desires—there is not a set departure time as exists when taking public transportation. Another advantage for the traveler driving an automobile is luggage. The traveler can just throw luggage into the automobile and begin driving. The luggage doesn't have to be locked for security; the luggage can even be an open shopping bag or paper bag; the luggage might even just be thrown into garbage bags. Clearly, there is a simplicity when driving an automobile for travel.

Airports, train stations, and bus terminals all dispose with quick and easy luggage transportation. With airplanes, trains, and buses, the traveler has luggage that is grouped with the luggage of all the other travelers. And therein lies the problem: How to ensure that the traveler can safely retrieve the traveler's luggage at the traveler's destination?

Yes, the traveler can attach a luggage identification tag to the traveler's luggage. The traveler can even tie a bright-colored ribbon to the luggage's handle to aid in luggage identification once the trip has ended and the traveler has reached a destination. But none of those solutions prevent luggage theft.

If a thief wants to grab the traveler's luggage at a carousel in an airport, for example, the thief merely needs to snag the luggage and leave the airport quickly. If the traveler is not fast enough to see the theft taking place, then the traveler won't be able to prevent the theft.

Many travelers place wireless transmitters in luggage to track luggage location. But knowing the location of luggage does not prevent luggage theft. For example, if luggage theft occurs, the traveler can see that a wireless transmitter indicates that the luggage has left the airport when the luggage should still be in the airport. And the traveler can even jump into an automobile to follow the luggage with hopes of retrieving the luggage. But in reality, the wireless transmitter does not prevent theft. Would the traveler even be able to safely confront the thief once the luggage has left the airport?

Thus, there is a need for a luggage solution that prevents luggage theft. All too often, luggage is stolen and the traveler is inconvenienced. Not having luggage at a destination means that the traveler is missing items that might not easily be replaceable immediately. And, of course, the monetary loss of property is unwelcomed—as is the time spent reporting luggage theft with hopes of reimbursement.

Locks on luggage seem like a great idea, but once luggage has been stolen, the thief can easily break the luggage open, completely defeating any lock.

### SUMMARY OF THE INVENTION

The present invention is anti-theft smart luggage that thwarts attempts to steal luggage. Nearly all modern luggage has wheels underneath the luggage on which to roll the luggage instead of lifting and carrying the luggage. The present invention has such wheels as well; however, the wheels of the present invention will automatically lock if the thumbprint of a user does not match the thumbprint of an owner of the luggage.

Nearly all modern luggage has a handle that telescopes from the luggage on an opposite side of the wheels of the luggage. Commonly, a button is pressed on the handle to allow the handle to telescope out from the luggage. Once the handle has telescoped from the luggage, the handle locks in position so the user can tip the luggage and push or pull the luggage via the wheels of the luggage. The present invention has a thumbprint reader on the button on the handle. If the thumbprint reader does not identify the thumbprint of the owner of the luggage, then the handle will not telescope out from the luggage. Further, as noted above, the wheels of the luggage will lock if the thumbprint reader does not identify the thumbprint of the owner of the luggage.

Thus, a thief will not be able to easily depart with luggage because a thumbprint of the thief will not match the thumbprint of the owner of the luggage—so the handle will not telescope for use and the wheels will lock. Imagine the thief having to actually carry luggage without using the handle telescoped and the locked wheels. Carrying luggage as such in an airport or other public venue would force the thief to stand out like a sore thumb compared to the multitudes of travelers using telescoped handles and rolling wheels under luggage. Moreover, carrying luggage is significantly more difficult than rolling luggage; thus, the thief would most likely abandon the luggage upon realizing that the luggage has to be carried. Making removal of luggage more difficult and obvious to observers is a primary focus of the present invention. The present invention dissuades removal of luggage unless the fingerprint of the user has been verified. Additionally, lights and sounds will activate to draw attention to the luggage if the thumbprint does not match.

### BRIEF DESCRIPTION OF DRAWINGS OF THE PRESENT INVENTION

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 shows an anti-theft luggage with a handle partially telescoped above a smart luggage body.

FIG. 2 shows various embodiments of the anti-theft luggage in various positions some embodiments lacking a telescoping handle and/or wheels.

FIG. 3 shows a different arrangement of the elements of the anti-theft luggage shown in FIG. 1.

FIG. 4 shows an alternate arrangement of the elements of the anti-theft luggage shown in FIGS. 1 and 3.

FIG. 5 depicts a basic view of an embodiment of the present invention, highlighting the biometric input present as a thumbprint reader.

### DETAILED DESCRIPTION OF THE PRESENT INVENTION

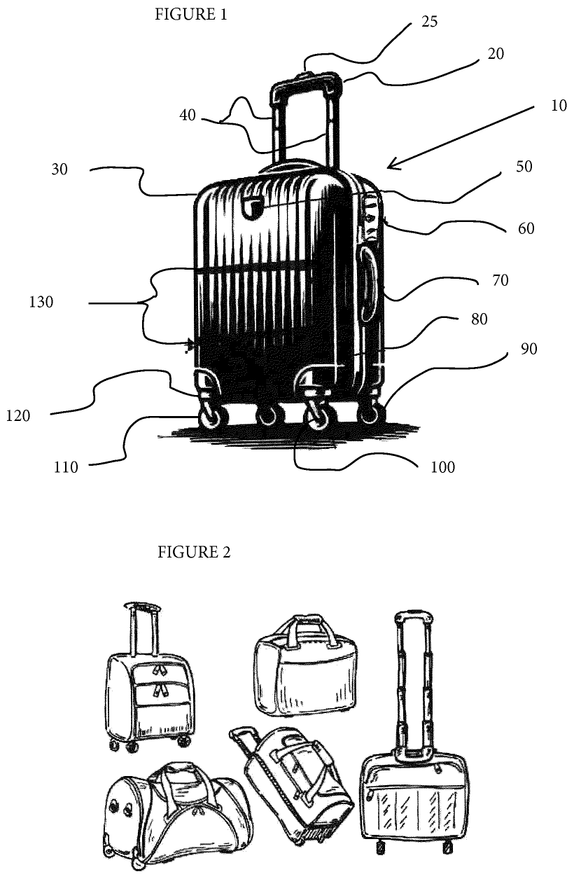

As shown in FIG. 1, smart luggage 10 is positioned in a typical fashion for transportation by a user. A handle 20 sits atop a body 30. Handle 20 can a handle equipped with a digital scale. Thumbprint reader 25 is positioned on handle 20. Alternately, the thumbprint reader 25 may be present on the body 30. Telescoping members 40 connect handle 20 to body 30. A global positioning system and proximity alert 50 is disposed on the side of body 30. Preferably, global positioning system and proximity alert 50 is disposed as part of or under a logo identification on luggage 10. Global positioning system and proximity alert 50 allows the user to conventionally track luggage 10 and receive conventionally implemented alerts when near or far from luggage 10. A USB charging port 60 is positioned on body 30 as well. Carrying handle 70 is located on body 30 as well. Zipper 80 is on body 30 to securely allow access to the inside of body 30. Preferably, zipper 80 is positioned along three sides of body 30. Wheels 90 are positioned below body 30. Wheels 90 are equipped with an auto-locking mechanism 100. Lights 110 and speaker 120 are disposed on wheels 90. Locking system 130 is shown as two bands across body 30.

It should be understood that in use, handle 20 is grasped by the user. Touching thumbprint reader 25 with a thumb of the user, the user is verified as an owner of smart luggage 10. Once verified, the user then extends handle 20 from body 30 via telescoping members 40 so that handle 20 is in position to be used for pushing or pulling luggage 10. Wheels 90 unlock once the user has been verified via touching thumbprint reader 25 with the thumb of the user, as described above. The user is able to thus push or pull luggage 10 around an airport or other area of use.

In this way, the user would seem to use luggage 10 like any other person moving a travel device. However, one difference is that the user has verified the identity of the user via thumbprint reader 25 to allow extension of handle 20 from body 30 via telescoping members 40 so that handle 20 is in position to be used for pushing or pulling luggage 10. A second difference between the user and any other person moving a travel device is that the user has verified the identity of the user via thumbprint reader 25 to allow wheels 90 to unlock via auto-locking mechanism 100. Most importantly, should a thief not verify identity of the user via thumbprint reader 25, lights 110 and speaker 120 will light up and sound, respectively, drawing attention to the thief—and quickly thwarting luggage theft. Moreover, locking system 130 are bands that prevent opening of luggage 10—even if zipper 80 is unzipped—if the user is unable to verify the identity of the user via thumbprint reader 25.

Various embodiments of the present invention are shown in FIG. 2. The shape of body 30 as well as the locations of handle 20, thumbprint reader 25, telescoping members 40, wheels 90, global positioning system and proximity alert 50, charging port 60, carrying handle 70, zipper 80, lights 110, speaker 120, and locking system 130 can vary. It is important to recognize that various versions of body 30, handle 20, thumbprint reader 25, telescoping members 40, wheels 90, global positioning system and proximity alert 50, charging port 60, carrying handle 70, zipper 80, lights 110, speaker 120, and locking system 130 exist—but the combination to function as described does not. Or in other words, the method of use as described and the method of functioning does not. It should be noted that handle 20 does not necessarily need to telescope should smart luggage 10 be a duffle bag or other luggage that conventionally does not have a handle 20 that telescopes. Similarly, wheels 90 might not be present on luggage 10—and in such case, lights 110 and speaker 120 would be disposed elsewhere such as on body 30.

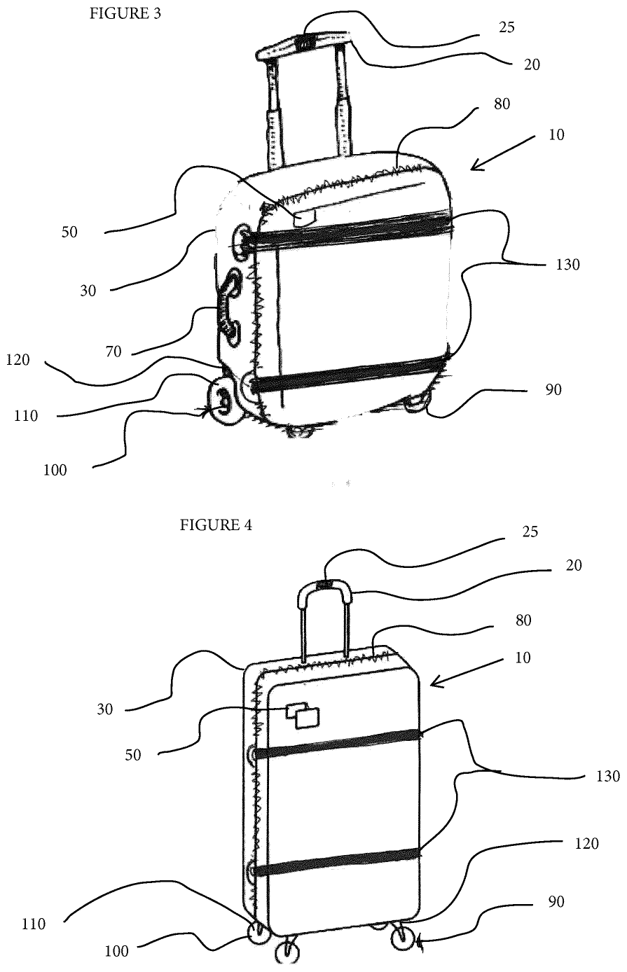

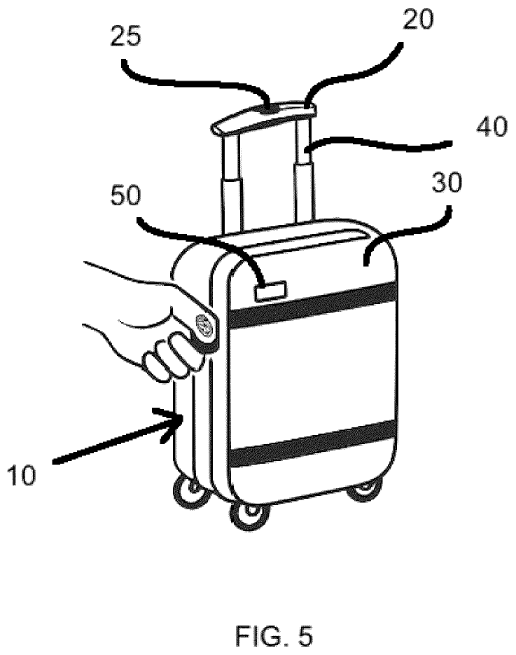

FIG. 3 shows that which is illustrated in FIG. 1. FIG. 3, though, shows a different arrangement of the elements of the present invention already explained above. Similarly, FIG. 4 shows that which is illustrated in FIG. 1. FIG. 3, though, shows a different arrangement of the elements of the present invention already explained above.

It should be understood that locking system 130 could be unlocked automatically via thumbprint reader 25, and then after a period of time, would automatically engage into a locked position. Moreover, thumbprint reader 25 could also be unlocked and locked remotely via software or via other conventional technology.

In some embodiments of the present invention, the locking system 130 may be configured to unlock upon the detection of a proximal Radio-Field Identification (RFID) tag or Near Field Communication (NFC) chip conventionally found within modern mobile devices (smartphones, tables, computers). In such embodiments, an RFID reader is disposed within the body 30, preferably in communication with the thumbprint reader 25 such that they are powered by the same battery. The RFID reader is configured to read a proximal RFID tag in the possession of the owner/user of the smart luggage of the present invention.

In other embodiments, a companion mobile device application preferably facilitates unlocking of the smart luggage (handle 20, wheels 90) upon a manual pressing of a button within the mobile device application. Further, in such embodiments, the smart luggage of the present invention may be equipped with a Bluetooth™ receiver, configured to connect to a Bluetooth™ transmitter of the mobile device, enabling the user to automatically unlock the locking features of the smart luggage (handle 20, wheels 90) upon connection of the mobile device to the present invention via a Bluetooth connection. In the event that the fingerprint read by the thumbprint reader 25 is incorrect, an alarm will sound and/or flashing lights will activate.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A smart luggage method, comprising:
verifying an identity of a user; and
upon proper verification, allowing wheels to roll, the wheels attached to luggage.

2. The smart luggage method of claim 1, further comprising flashing lights upon improper verification.

3. The smart luggage method of claim 1, further comprising sounding a speaker upon improper verification.

4. The smart luggage method of claim 1, further comprising preventing the wheels from rolling upon improper verification.

5. A smart luggage method, comprising:
requiring verification for extension of a handle; and
requiring verification for allowing wheels to roll.

6. The smart luggage method of claim 5, further comprising sounding an alarm and flashing lights upon improper verification.

7. A smart luggage method, comprising:
verifying identity of a user; and
upon proper verification, extending a handle from a luggage body.

8. The smart luggage method of claim 7, further comprising flashing lights upon improper verification.

9. The smart luggage method of claim 7, further comprising sounding a speaker upon improper verification.

10. The smart luggage method of claim 7, further comprising preventing the handle from extending upon improper verification.

11. The smart luggage method of claim 7, further comprising a biometric device facilitating the verification of the identity of the user.

12. The smart luggage method of claim 8, further comprising sounding a speaker upon improper verification.

13. The smart luggage method of claim 8, further comprising preventing the handle from extending upon improper verification.

14. The smart luggage method of claim 8, further comprising a biometric device facilitating the verification of the identity of the user.

15. The smart luggage method of claim 9, further comprising a biometric device facilitating the verification of the identity of the user.
